(19) United States
(12) Patent Application Publication
(10) Pub. No.: US 2004/0267037 A1
(43) Pub. Date: Dec. 30, 2004

(54) Compound according to the formula (xr5-)(y+)and a process for the synthesis of such a compound

(76) Inventors: Sirik Deerenberg, Delft (NL); Koop Lammertsma, Amsterdam (NL); Marius Schakel, Amsterdam (NL); Mirko Kranenburg, Maastricht (NL); Adrianus Keijzer, De, Hoogerheide (NL)

Correspondence Address: MAYER, BROWN, ROWE & MAW LLP, 1909 K STREET, N.W., WASHINGTON, DC, 20006, US

(21) Appl. No.: 10/480,283

(22) PCT Filed: Jun. 11, 2002
(86) PCT No.: PCT/NL02/00380

(30) Foreign Application Priority Data
Jun. 12, 2001 (NL) 1018270

(51) Int. Cl. C07F 7/22; C07F 7/24; C07F 7/30

(52) U.S. Cl. 556/107

(57) ABSTRACT

The invention relates to a compound according to the formula (XR₅⁻)(NR′₄⁺), wherein X represents Si, Ge, Sn or Pb, the R groups may be the same or different, each being a monoanion chosen from the group comprising hydrogen, an alkyl group, an aryl group, an arylalkyl group, and the R′ groups may be the same or different, each representing a hydrocarbon group containing 1-10 carbon atoms. The invention also relates to a process for the preparation of a compound of formula (XR₅⁻)(NR′₄⁺), to an ion exchange process wherein the NR′₄⁺ is exchanged for another cation, and to the use of (XR₅⁻)(NR′₄⁺) and the product of said ion exchange process as a cocatalyst in the polymerization of olefins.

The invention relates to a process for the preparation of a compound according to the formula (XR₅⁻)(Y⁺), wherein X represents Si, Ge, Sn or Pb, the R groups may be the same or different, each being a monoanion chosen from the group comprising hydrogen, an alkyl group, an aryl group, an arylalkyl group, and an alkylaryl group, and Y⁺ represents a cation. The invention also relates to a compound according to the formula (XR₅⁻)(Y⁺), and to the use of a compound of formula (XR₅⁻)(Y⁺).

A process for the preparation of a compound according to the formula (XR₅⁻)(Y⁺) is disclosed in for example “The Journal of Organometallic Chemistry”, Vol. 548 (1997), p. 29-32.

A drawback of the known process is that it usually results in products (XR₅⁻)(Y⁺) in the form of oily liquids, which often are of limited purity and difficult to purify.

The aim of the present invention is therefore to provide a process by which compounds of the formula (XR₅⁻)(Y⁺) can be obtained in higher purity.

It has now been found that this can be achieved by using as Y⁺ a cation having the formula NR′₄⁺, wherein the R′ groups may be the same or different, each representing a hydrocarbon group containing 1-10 carbon atoms. Compounds having the formula (XR₅⁻)(NR′₄⁺) can be obtained as solid substances which can readily be isolated after synthesis. The compounds are crystallizable and may be isolated as substantially pure substances without any significant amounts of by-products.

In the compounds according to the formula (XR₅⁻)(NR′₄⁺), each R′ represents a hydrocarbon group containing 1-10 carbon atoms. This hydrocarbon group may be a linear, branched or cyclic hydrocarbon group, and may be substituted. Examples of suitable hydrocarbon groups are methyl, ethyl, n-butyl, t-butyl, phenyl, n-octyl and isobutyl. The hydrocarbon group preferably is a linear hydrocarbon group. R′ preferably contains 1-5 carbon atoms. Preferably the hydrocarbon groups R′ are the same.

X in the compounds according to the formula (XR₅⁻)(NR′₄⁺) preferably represents Si, amongst others because Si is less toxic than Ge, Sn and Pb.

The R groups in (XR₅⁻)(NR′₄⁺) may be the same or different and are chosen from the group comprising hydrogen, an alkyl group, an aryl group, an arylalkyl group, and an alkylaryl group. The alkyl group, the aryl group, the arylalkyl group, and the alkylaryl group may be substituted. Preferably the R group is a hydrocarbon group containing 1-20 carbon atoms. Examples of suitable R groups are methyl, ethyl, propyl, isopropyl, hexyl, decyl and phenyl. 2 R groups may also together form a bridged R₂ group. Preferably at least 2 R groups together form a bridged aryl group, such as for example a biphenyl-2,2′-diyl group and a diphenyl-2,2′-diylmethane group. It is especially preferred for the compound according to the formula (XR₅⁻)(NR′₄⁺) to contain two such bridged aryl groups, since in this way the compound has a higher thermal stability than a compound without bridged aryl groups.

The invention also relates to a process for the preparation of the compound having formula (XR₅⁻)(NR′₄⁺), in which XR₄, AₙM and R′₄NB are reacted. Herein X, R, and R′ are defined as above, A represents an optionally substituted (hetero)alkyl or (hetero)aryl group containing 1-10 carbon atoms, which is bound to M via a C atom. A is preferably chosen from the group comprising methyl, n-butyl, sec-butyl, vinyl, and phenyl. M represents an alkali or alkaline earth metal ion or MgZ, wherein Z represents Cl, Br or I. Preferably M represents Li, Na or K, more preferably Li. n is 1 or 2, depending on the charge of M. In the compound R′₄NB, B is chosen from Cl, Br, and I. B preferably represents Br.

Two preferred embodiments of the process according to the invention, defined as Process 1 and Process 2, respectively, are described below.

Process 1 starts from a compound with formula XR₄ that reacts with AₙM, wherein A and M are defined as above, and subsequently with a compound of formula R′₄NB. The solid product formed can be isolated using techniques commonly known in the art, for example by filtration or centrifugation.

Process 2 starts from a compound with formula R′₄NB, that reacts with AₙM, wherein A and M are defined as above, and subsequently with a compound of formula XR₄. As in Process 1, the solid product formed can be isolated using techniques commonly known in the art, for example by filtration or centrifugation.

Both processes are generally performed in the presence of a solvent. Preferably an aprotic solvent is used, more preferably an aprotic polar solvent, in particular an ether, for example diethyl ether, tetrahydrofuran or dioxane.

The above processes are generally carried out at a temperature between −100 and 50° C., preferably at a temperature between −80 and 30° C. The processes may be carried out at any pressure. For practical reasons, however, atmospheric pressure is preferred.

The process is preferably performed in an inert atmosphere, for example in a nitrogen or argon atmosphere.

For the preparation of (XR₅⁻)(NR′₄⁺) preferably Process 1 is practiced, because that process is easier to perform than Process 2.

The invention also relates to the novel compound of formula (XR₅⁻)(NR′₄⁺).

The compound of formula (XR₅⁻)(NR₄⁺) may be subjected to an ion exchange process wherein the NR′₄⁺ cation is exchanged for another cation, for example a Bronsted acid which is capable of donating a proton, a cation of an alkali metal or a carbenium cation. Examples of such cations are Li⁺; K⁺; Na⁺; H⁺; triphenylcarbenium; anilinium; guanidinium; glycinium; ammonium; a substituted ammonium cation, in which at most three hydrogen atoms have been replaced by a hydrocarbyl radical having 1-20 carbon atoms; a substituted hydrocarbyl radical having 1-20 carbon atoms, in which one or more of the hydrogen atoms has or have been replaced by a halogen atom; a phosphonium radical; a substituted phosphonium radical, in which at most three hydrogen atoms have been replaced by a hydrocarbyl radical having 1-20 carbon atoms; and a substituted hydrocarbyl radical having 1-20 carbon atoms, in which one or more of the hydrogen atoms has or have been replaced by a halogen atom. The cation is preferably dimethylanilinium, triphenylcarbenium or Li⁺. Ion exchange processes are commonly known in the art and can easily be performed by a skilled person.

(XR₅⁻)(NR′₄⁺) and the product of said ion exchange process can suitably be used as a co-catalyst in the polymerization of one or more olefins in combination with a transition-metal catalyst. Such a use is described in EP-A-954,539.

An advantage of using (XR₅⁻)(NR′₄⁺) according to the invention or the product of said ion exchange process as a co-catalyst in the polymerisation of olefins is their high purity. The use of such high purity co-catalysts reduces the chance on side reactions during the polymerisation process and may result in a higher efficiency of the polymerisation process.

Examples of transition metal catalysts which can be used in combination with the compounds of the invention as co-catalysts are described in U.S. Pat. No. 5,096,867, WO-A-92/00333, EP-A-347,129, EP-A-344,887, EP-A-129,368, EP-A-476,671, EP-A-468,651, EP-A-416,815, EP-A-351,391, EP-A-351,392, EP-A-423,101, EP-A-503,422, EP-A-516,018, EP-A-490,256, EP-A-485,820, EP-A-376,154, DE-A-4,015,254, WO-A-96/13529, EP-A-530,908, WO-A-94/11406, EP-A-672,676 and WO-A-96/23010. Transition-metal catalysts containing metals from group 3 of the Periodic Table of the Elements and the lanthanides can also be used. Preferably metallocene catalysts are used. Metallocene catalysts are characterized by the presence in the transition-metal catalyst of one or more π-bound ligands, such as cyclopentadiene ligands (Cp) or cyclopentadiene-related ligands, for example indene and fluorene. The use of a transition-metal catalyst in which the transition metal is in a reduced oxidation state, as described in WO-A-96/13529, is particularly preferred.

Both the cocatalyst and the transition metal compound are optionally immobilized on a carrier. SiO₂, Al₂O₃, MgCl₂ and polymer particles, such as polystyrene spherules, can be mentioned as suitable carrier materials. These carrier materials can also be modified with for example silanes and/or aluminoxanes and/or aluminium alkyls: The supported co-catalysts and transition-metal catalysts can be synthesized prior to the polymerization, but they can also be formed in situ.

The polymerisation of olefins, for example ethylene, propylene, butene, hexene, octene and mixtures thereof and combinations with dienes can be conducted in the presence of a catalyst system, comprising a transition-metal catalyst and the co-catalyst according to the invention. This catalyst system can also be used for the polymerization of vinylaromatic monomers, such as styrene and p-methylstyrene, for the polymerization of polar vinyl monomers, such as alcohols, amines, alkyl halides, ethers, amides, imines and anhydrides, and for the polymerization of cyclic olefins, such as cyclobutene, cyclopentene, cyclohexene, cycloheptene, cyclooctene, norbornene, dimethanooctahydronaphthalene and substituted norbornenes.

The amount of co-catalyst used relative to the amount of transition-metal catalyst (mol:mol) is normally 1:100-1000:1, preferably 1:5-250:1.

The polymerizations can be carried out in the known manner and the use of the co-catalyst according to the invention does not necessitate any essential modification of these processes. The known polymerizations are carried out in suspension, solution, emulsion, gas phase or as bulk polymerization. When the co-catalyst is used in suspension or gas-phase polymerization it is to be preferred to use the transition-metal catalyst or the co-catalyst according to the invention on a support. It is also possible to use both the catalyst and the co-catalyst on a support.

The polymerizations are carried out at temperatures between −50° C. and +350° C. Preferably between 50° C. and 250° C.

The pressures used generally lie between atmospheric pressure and 250 MPa; for bulk polymerizations more in particular between 50 and 250 MPa, for the other polymerization processes between 0.5 and 25 MPa.

As dispersants and solvents during the polymerization, substituted and unsubstituted hydrocarbons can for example be used, such as pentane, heptane and mixtures thereof. Aromatic, possibly perfluorinated hydrocarbons can also be considered. A monomer to be used in the polymerization can also be used as dispersant.

The invention is elucidated with reference to the following Examples without being limited thereto.

### EXAMPLES I-IV

General

The starting materials used were obtained from Acros Chimica and Aldrich Chemical Co.

Standard Schlenck techniques were applied. All reactions were carried out in flame-dried glassware under a nitrogen atmosphere. Dichloromethane was distilled over CaH₂. Tetrahydrofuran (THF) was distilled over LiAlH₄.

Nuclear Magnetic Resonance (NMR) spectra were obtained on a Bruker MSL 400 spectrometer.

### Example I

Preparation of tetrabutylammonium bis(2,2′-biphenyldiyl)methylsilicate

Process 1

9,9′-spirobi(9H-9-silafluorene) (0.022 g, 0.066 mmol) was dissolved in a mixture of THF-d⁸/THF (0.5 ml, 1/9) in an NMR tube at room temperature. Upon cooling to −78° C., a solution of methyllithium in diethylether (0.045 ml, 1.6 M, 0.073 mmol) was added. After 15 minutes, the solution was heated to room temperature and an orange solution was obtained. NMR analysis indicated that a quantitative conversion to lithium bis(2,2′-biphenyldiyl)methylsilicate had taken place.

The NMR tube was cooled back to −78° C. and a solution of tetrabutylammonium bromide (0.021 g, 0.066 mmol) in CH₂Cl₂ (0.5 ml) was added. A white suspension was immediately formed and the reaction mixture was heated to room temperature. After centrifuging, the supernatant liquid was decanted and the solid substance was washed with THF. After vacuum-drying, tetrabutylammonium bis(2,2′-biphenyldiyl)methylsilicate was quantitatively obtained as a white solid.

The end product was characterized through ¹H NMR, ¹³C NMR and ²⁹Si NMR, which indicated that the aforementioned compound had been obtained.

Process 2

A solution of methyllithium in diethylether (0.037 ml, 1.6M, 0.059 mmol) was added to a solution of tetrabutylammonium bromide (0.019 g, 0.059 mmol) in a mixture of THF-d⁸/THF (0.5 ml, 1/9) in an NMR tube at −78° C. After 15 minutes, 9,9′-spirobi(9H-9-silafluorene) (0.019 g, 0.059 mmol) was added at −78° C. After another 15 minutes the solution was heated to room temperature and a white suspension was obtained. After centrifuging, the supernatant liquid was decanted and the solid substance was washed with THF. After vacuum-drying, tetrabutylammonium bis(2,2′-biphenyldiyl)methyl silicate was quantitatively obtained as a white solid substance.

The end product was characterized through ¹H NMR and ²⁹Si NMR, which indicated that the aforementioned compound had been obtained.

### Example II

Preparation of tetrabutylammonium bis(2,2′-biphenyldiyl)phenyl silicate)

9,9′-spirobi(9H-9-silafluorene) (0.021 g, 0.065 mmol) was dissolved in a mixture of THF-d⁸/THF (0.5 ml, 1/9) in an NMR tube at room temperature. Upon cooling to −78° C., a solution of phenyllithium in cyclohexane/ether (70/30) (0.036 ml, 1.8 M, 0.072 mmol) was added. After 15 minutes a solution of tetrabutylammonium bromide (0.021 g, 0.065 mmol) in CH₂Cl₂ (0.5 ml) was added. A white suspension was immediately formed and the reaction mixture was heated to room temperature. After centrifuging, the supernatant liquid was decanted and the solid substance was washed with THF. After vacuum-drying, tetrabutylammonium bis(2,2′-biphenyldiyl)phenylsilicate was quantitatively obtained as a white solid substance. The end product was characterized through ¹H NMR and ²⁹Si NMR, which indicated that the aforementioned compound had been obtained.

### Example III

Preparation of tetraethylammonium bis(2,2′-biphenyldiyl)methylsilicate)

9,9′-spirobi(9H-9-silafluorene) (0.022 g, 0.066 mmol) was dissolved in a mixture of THF-d⁸/THF (0.5 ml, 1/9) in an NMR tube at room temperature. Upon cooling to −78° C., a solution of methyllithium in ether (0.045 ml, 1.6 M, 0.073 mmol) was added. After 15 minutes the solution was heated again to room temperature and an orange solution was obtained. NMR analysis indicated that a quantitative conversion to lithium bis(2,2′-biphenyldiyl)silicate had taken place.

The NMR tube was cooled again to −78° C. and a solution of tetraethylammonium bromide (0.014 g, 0.066 mmol) in dicloromethane (0.5 ml) was added. A white suspension was immediately formed and the reaction mixture was heated to room temperature. After centrifuging, the supernatant liquid was decanted and the solid substance was washed with THF. After vacuum-drying, tetraethylammonium bis(2,2′-biphenyl)methylsilicate was quantitatively obtained as a white solid substance.

The end product was characterized through ¹H NMR and ²⁹Si NMR, which indicated that the aforementioned compound had been obtained.

### Example IV

Preparation of tetraethylammonium bis(2,2′-biphenyldiyl)phenyl silicate

9,9′-spirobi(9H-9-silafluorene) (0.042 g, 0.126 mmol) was dissolved in a mixture of THF-d⁸/THF (0.5 ml, 1/9) in an NMR tube at room temperature. After cooling to −78° C., a solution of phenyl lithium in cyclohexane/diethylether (70/30) (0.084 ml, 1.8 M, 0.152 mmol) was added. After 15 minutes, a solution of tetraethylammonium bromide (0.27 g, 0.126 mmol) in CH₂Cl₂ (0.5 ml) was added. A white suspension was immediately formed and the reaction mixture was slowly heated to room temperature. After centrifuging, the supernatant liquid was decanted and the solid substance was washed with THF. After vacuum-drying, tetraethylammonium bis(2,2′-biphenyldiyl)phenyl silicate was quantitatively obtained as a white solid.

The end product was characterized through ¹H NMR and ²⁹Si NMR, which indicated that the aforementioned compound had been obtained.

### Example V

Ion Exchange of NR′₄ Cations and Polymerisation of Ethylene

The compounds obtained by Example I-IV were subjected to an ion exchange reaction exchanging the NR′₄ cations by anilinium cations. The resulting anilinium salts were used as co-catalysts in the polymerisation of ethylene to yield polyethylene.

1. Compound according to the formula (XR₅⁻)(Y⁺), wherein X represents Si, Ge, Sn or Pb, the R groups may be the same or different, each being a monoanion chosen from the group comprising hydrogen, an alkyl group, an aryl group, an arylalkyl group, and an alkylaryl group, and Y⁺ a cation, characterized in that Y+ represents a cation according to the formula NR′₄⁺ wherein the R′ groups may be the same or different, each representing a hydrocarbon group containing 1-10 carbon atoms.

2. Compound according to claim 1, wherein R′ is a linear hydrocarbon group.

3. Compound according to claim 1, wherein R′ is a hydrocarbon group containing 1-5 carbon atoms.

4. Compound according to claim 1, wherein X represents Si.

5. Compound according to claim 1, wherein 2 R groups together form a bridged aryl group.

6. Process for the preparation of a compound according to claim 1, wherein XR₄, AₙM and R′₄NB are reacted, in which X, R, and R′ are defined as above, A represents an optionally substituted (hetero) alkyl or (hetero) aryl group containing 1-10 carbon atoms, which is bound to M via a C atom, M represents an alkali or alkaline earth metal ion or MgZ, wherein Z represents Cl, Br or I, n is 1 or 2, and B is chosen from Cl, Br, and 1.

7. Process according to claim 6, wherein in a first step a compound of formula XR₄ is reacted with AₙM, and the product is subsequently reacted in a second step with a compound of formula R′₄NB.

8. Process according to claim 6, wherein in a first step a compound of formula R′₄NB is reacted with AₙM, and the product is subsequently reacted in a second step with a compound of formula XR₄.

9. Process according to claim 7, wherein A represents a methyl or a phenyl group, M represents Li, and n equals 1.

10. Process according to claim 7, wherein B represents Br.

11. Ion exchange process wherein the NR′₄⁺ cation of a compound according to claim 1 is exchanged for a cation chosen from the group comprising a Bronsted acid which is capable of donating a proton, a cation of an alkali metal, and a carbenium cation.

12. (Canceled.)

13. Ion exchange process wherein the NR′₄⁺ cation of a compound obtained by a process according to claim 6 is exchanged for a cation which is a Bronsted acid which is capable of donating a proton, a cation of an alkali metal or a carbenium cation.

14. Process for polymerization of one or more olefins which comprises polymerizing one or more olefins in the presence of a compound obtained by a process according to claim 6.
